(19) United States
(12) Patent Application Publication
(10) Pub. No.: US 2026/0323729 A1
(43) Pub. Date: Oct. 15, 2026

(54) COMMUNICATION METHOD, TERMINAL, AND NETWORK-SIDE DEVICE

(71) Applicant: VIVO MOBILE COMMUNICATION CO., LTD., Dongguan (CN)

(72) Inventors: Chengrui WANG, Dongguan (CN); Zhipeng LIN, Dongguan (CN); Wei BAO, Dongguan (CN)

(73) Assignee: VIVO MOBILE COMMUNICATION CO., LTD., Dongguan, GD (CN)

(21) Appl. No.: 19/686,966

(22) Filed: May 25, 2026

Related U.S. Application Data
(63) Continuation of application No. PCT/CN2024/133920, filed on Nov. 22, 2024.

(30) Foreign Application Priority Data
Nov. 24, 2023 (CN) 202311588137.9

(51) Int. Cl. H04W 74/08; H04W 56/00; H04W 74/0833

(52) U.S. Cl. CPC H04W 74/0891; H04W 56/0015; H04W 74/0833

(57) ABSTRACT

This application discloses a communication method, a terminal, and a network-side device. The method includes: receiving, by a terminal, first configuration information from a network-side device, wherein the first configuration information is used to configure a flexible Physical Random Access Channel (PRACH) resource associated with at least one Synchronization Signal Block (SSB); and determining, by the terminal, a result of association between the at least one SSB and a PRACH resource based on the first configuration information.

### CROSS-REFERENCE TO RELATED APPLICATIONS

This application is a continuation application of International Application No. PCT/CN2024/133920, filed on Nov. 22, 2024, which claims priority to Chinese Patent Application No. 202311588137.9, filed with the China National Intellectual Property Administration on Nov. 24, 2023 and entitled “COMMUNICATION METHOD, TERMINAL, AND NETWORK-SIDE DEVICE”, contents of both of which are incorporated herein by reference in their entirety for all purposes.

### TECHNICAL FIELD

This application pertains to the field of communication technologies, and specifically relates to a communication method, a terminal, and a network-side device.

### BACKGROUND

A synchronization signal/physical broadcast channel block (SS/PBCH block, SSB) in 5G includes a Primary Synchronization Signal (PSS), a Secondary Synchronization Signal (SSS), a Physical Broadcast Channel (PBCH), and a De-modulation Reference Signal (DMRS). In addition, a cell may configure a plurality of PRACH transmission occasions (or referred to as PRACH Occasions, or referred to as ROs for short) for Frequency Division Multiplexing (FDM) at a time domain location for Physical Random Access Channel (PRACH) transmission.

In a related technology, a PRACH resource is statically configured for a current cell by using RRC signaling, and cannot be dynamically changed. In a future communication system (such as a 6G communication system), a more flexible PRACH resource configuration may be performed, for example, some flexible PRACH resources that can be dynamically activated or deactivated are additionally configured. However, how to associate the additionally configured flexible PRACH resources with the SSB is urgently to be resolved.

### SUMMARY

According to a first aspect, a communication method is provided. The method is performed by a terminal, and includes:

The terminal receives first configuration information from a network-side device, where the first configuration information is used to configure a flexible Physical Random Access Channel (PRACH) resource associated with at least one Synchronization Signal Block (SSB).

The terminal determines a result of association between the at least one SSB and a PRACH resource based on the first configuration information.

According to a second aspect, a communication method is provided. The method is performed by a network-side device, and includes:

The network-side device determines first configuration information, where the first configuration information is used to configure a flexible Physical Random Access Channel (PRACH) resource associated with at least one Synchronization Signal Block (SSB).

The network-side device sends the first configuration information to a terminal.

According to a third aspect, a communication apparatus is provided, including:
a receiving module, configured to receive first configuration information from a network-side device, where the first configuration information is used to configure a flexible Physical Random Access Channel (PRACH) resource associated with at least one Synchronization Signal Block (SSB); and
a determining module, configured to determine a result of association between the at least one SSB and a PRACH resource based on the first configuration information.

According to a fourth aspect, a communication apparatus is provided, including:
a determining module, configured to determine first configuration information, where the first configuration information is used to configure a flexible Physical Random Access Channel (PRACH) resource associated with at least one Synchronization Signal Block (SSB); and
a sending module, configured to send the first configuration information to a terminal.

According to a fifth aspect, a terminal is provided. The terminal includes a processor and a memory. The memory stores a program or instructions capable of running on the processor, and the program or the instructions are executed by the processor to implement the steps of the method according to the first aspect.

According to a sixth aspect, a terminal is provided, including a processor and a communication interface. The communication interface is configured to receive first configuration information from a network-side device, and the first configuration information is used to configure a flexible Physical Random Access Channel (PRACH) resource associated with at least one Synchronization Signal Block (SSB). The processor is configured to determine a result of association between the at least one SSB and a PRACH resource based on the first configuration information.

According to a seventh aspect, a network-side device is provided. The network-side device includes a processor and a memory. The memory stores a program or instructions capable of running on the processor, and the program or the instructions are executed by the processor to implement the steps of the method according to the second aspect.

According to an eighth aspect, a network-side device is provided, including a processor and a communication interface. The processor is configured to determine first configuration information, and the first configuration information is used to configure a flexible Physical Random Access Channel (PRACH) resource associated with at least one Synchronization Signal Block (SSB). The communication interface is configured to send the first configuration information to a terminal.

According to a ninth aspect, a readable storage medium is provided. The readable storage medium stores a program or instructions, and the program or the instructions are executed by a processor to implement the steps of the method according to the first aspect or to implement the steps of the method according to the second aspect.

According to a tenth aspect, a wireless communication system is provided, including a terminal and a network-side device. The terminal may be configured to perform the steps of the method according to the first aspect, and the network-side device may be configured to perform the steps of the method according to the second aspect.

According to an eleventh aspect, a chip is provided. The chip includes a processor and a communication interface, the communication interface is coupled to the processor, and the processor is configured to run a program or instructions to implement the method according to the first aspect or to implement the method according to the second aspect.

According to a twelfth aspect, a computer program/program product is provided. The computer program/program product is stored in a storage medium. The computer program/program product is executed by at least one processor to implement the steps of the communication method according to the first aspect or the steps of the communication method according to the second aspect.

### BRIEF DESCRIPTION OF DRAWINGS

FIG. 1 is a block diagram of a wireless communication system to which an embodiment of this application is applicable;

FIG. 2 is a schematic diagram of mapping from an SSB to an RO;

FIG. 3 is another schematic diagram of mapping from an SSB to an RO;

FIG. 4 is a schematic diagram of mapping from an SSB to an RO group;

FIG. 5 is a schematic flowchart of a communication method according to an embodiment of this application;

FIG. 6 is a schematic flowchart of another communication method according to an embodiment of this application;

FIG. 7A is a schematic diagram of a result of association between an SSB and an RO according to an embodiment of this application;

FIG. 7B is a schematic diagram of another result of association between an SSB and an RO according to an embodiment of this application;

FIG. 8A is a schematic diagram of another result of association between an SSB and an RO according to an embodiment of this application;

FIG. 8B is a schematic diagram of another result of association between an SSB and an RO according to an embodiment of this application;

FIG. 9A is a schematic diagram of another result of association between an SSB and an RO according to an embodiment of this application;

FIG. 9B is a schematic diagram of another result of association between an SSB and an RO according to an embodiment of this application;

FIG. 10 is a schematic block diagram of a communication apparatus according to an embodiment of this application;

FIG. 11 is a schematic block diagram of another communication apparatus according to an embodiment of this application;

FIG. 12 is a schematic block diagram of a communication device according to an embodiment of this application;

FIG. 13 is a schematic diagram of a structure of a terminal according to an embodiment of this application; and

FIG. 14 is a schematic diagram of a structure of a network-side device according to an embodiment of this application.

### DETAILED DESCRIPTION

The following clearly describes technical solutions in embodiments of this application with reference to accompanying drawings in embodiments of this application. Clearly, the described embodiments are merely a part rather than all of the embodiments of this application. All other embodiments obtained by a person of ordinary skill in the art based on embodiments of this application shall fall within the protection scope of this application.

The terms “first”, “second”, and the like in this application are used to distinguish between similar objects instead of describing a specified order or sequence. It should be understood that terms used in this way are interchangeable under appropriate circumstances, so that the embodiments of this application can be implemented in a sequence other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, a solution 1: including A and not including B; a solution 2: including B and not including A; and a solution 3: including both A and B. The character “/” generally represents an “or” relationship between associated objects.

The term “indication” in this application may be a direct indication (or an explicit indication), or may be an indirect indication (or an implicit indication). The direct indication may be understood as follows: A sender explicitly notifies, in a sent indication, a receiver of specific information, an operation that needs to be performed, a requested result, or other content. The indirect indication may be understood as follows: The receiver determines corresponding information based on the indication sent by the sender, or performs determining based on the indication sent by the sender, and determines, based on a determining result, the operation that needs to be performed or the requested result.

It should be noted that a technology described in embodiments of this application is not limited to a Long Term Evolution (LTE)/LTE-Advanced (LTE-A) system, and may be further applied to other wireless communication systems, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency-Division Multiple Access (SC-FDMA) system, or another system. The terms “system” and “network” are often used interchangeably in embodiments of this application. The technology described may be used for the systems and radio technologies described above, as well as other systems and radio technologies. The following describes a New Radio (NR) system for illustrative purposes, and NR terms are used in most of the following descriptions. However, these technologies are also applicable to systems such as a 6^{th} Generation (6G) communication system other than the NR system.

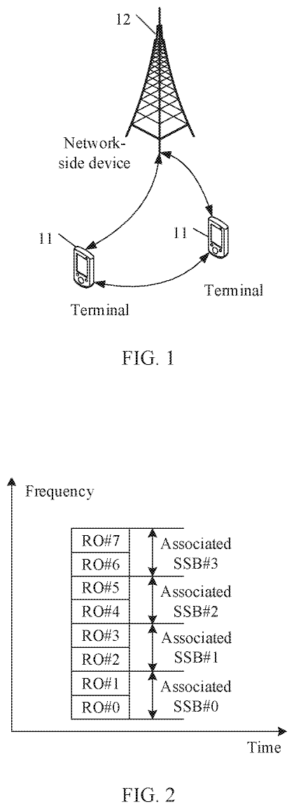

FIG. 1 is a block diagram of a wireless communication system to which an embodiment of this application is applicable. The wireless communication system includes a terminal 11 and a network-side device 12. The terminal 11 may be a mobile phone, a tablet personal computer, a laptop computer, a notebook computer, a Personal Digital Assistant (PDA), a palmtop computer, a netbook, an Ultra-mobile Personal Computer (UMPC), a Mobile Internet Device (MID), an Augmented Reality (AR)/Virtual Reality (VR) device, a robot, a wearable device, a flight vehicle, Vehicle User Equipment (VUE), ship-mounted equipment, Pedestrian User Equipment (PUE), a smart home (a home device with a wireless communication function, for example, a refrigerator, a television, a laundry machine, or a furniture), a gaming console, a Personal Computer (PC), a teller machine, a self-service machine, or another terminal-side device. The wearable device includes: a smartwatch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in embodiments of this application. The network-side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (WiFi) node, and the like. The base station may be referred to as a NodeB (NB), an evolved NodeB (eNB), the next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a home NodeB (HNB), a home evolved NodeB, a Transmission Reception Point (TRP), or another proper term in the field. The base station is not limited to a specific technical term, provided that the same technical effect is achieved. It should be noted that in embodiments of this application, only a base station in an NR system is used as an example for description, and a specific type of the base station is not limited.

First, a rule of mapping from an SSB to a transmission occasion (RO) in this application is described.

A synchronization signal/physical broadcast channel block (SS/PBCH block, SSB) in 5G includes a Primary Synchronization Signal (PSS), a Secondary Synchronization Signal (SSS), a Physical Broadcast Channel (PBCH), and a De-modulation Reference Signal (DMRS). A wireless device (terminal) provides a synchronization signal and a broadcast signal/channel from a base station cell to perform time-frequency-domain synchronization with a base station through a cell search process, and obtains locations of a time-frequency resource of a cell deployed by the base station in frequency domain and time domain, and a physical cell ID.

The terminal further receives a System Information Block (SIB) 1 by receiving the SSB, where the SIB1 includes various parameters of initial access. Configuration parameters of a PRACH resource and the rule of mapping from the SSB to the RO are configured in the System Information Block (SIB)1. In an NR system, a cell may configure a plurality of ROs for FDM at a time domain location for PRACH transmission. At a moment, a quantity of ROs on which FDM can be performed may be: {1, 2, 4, 8}, which is configured and determined by using a higher-layer parameter msg1-FDM.

A random access preamble can be transmitted only on a time domain resource configured by using a parameter PRACHConfigurationIndex and a frequency domain resource configured by using the parameter msg1-FDM. A PRACH frequency domain resource n_{RA}∈{0,1, . . . , M−1}, where M is equal to the higher-layer parameter msg1-FDM. During initial access, the PRACH frequency domain resource is numbered in ascending order starting from an RO resource with a lowest frequency within an initial active uplink bandwidth part. Otherwise, the PRACH frequency domain resource is numbered in ascending order starting from an RO resource with a lowest frequency within an active uplink bandwidth part. For example, in FIG. 2, a quantity of FDM ROs at a moment is 8 (msg1-FDM=8), and RO resources are sequentially numbered RO #0 to RO #7 in ascending order of frequencies.

In the NR system, there is an association relationship between an RO and an actually sent SSB. The RO is associated with the SSB in an order of frequency domain (from low frequency to high frequency) and time domain. An SSB may be associated with a plurality of consecutive ROs, or a plurality of SSBs may be associated with one RO (in this case, different SSBs correspond to different preambles). This is configured by a network by using a parameter ssb-perRACH-OccasionAndCB-PreamblesPerSSB.

```
    ssb-perRACH-OccasionAndCB-PreamblesPerSSB CHOICE {
    oneEighth
  ENUMERATED{n4,n8,n12,n16,n20,n24,n28,n32,n36,n40,n44,n48,n52,n56,n60,n64
},
    oneFourth
  ENUMERATED{n4,n8,n12,n16,n20,n24,n28,n32,n36,n40,n44,n48,n52,n56,n60,n64
},
    oneHalf
  ENUMERATED{n4,n8,n12,n16,n20,n24,n28,n32,n36,n40,n44,n48,n52,n56,n60,n64
},
    one
  ENUMERATED{n4,n8,n12,n16,n20,n24,n28,n32,n36,n40,n44,n48,n52,n56,n60,n64
},
```

| | |
|---|---|
| two | ENUMERATED{n4,n8,n12,n16,n20,n24,n28,n32 }, |
| four | INTEGER(1..16), |
| eight | INTEGER(1..8), |
| sixteen | INTEGER(1..4), |
| } | OPTIONAL,--Need |

For example, oneEighth represents that one SSB is associated with eight consecutive ROs, eight represents that eight SSBs are associated with one RO, and {n4, n8, n12, . . . } represents a quantity of consecutive preambles associated with one SSB on one RO, for example, a value n4 represents that a quantity of consecutive preambles associated with one SSB on one RO is 4, and n8 represents that a quantity of consecutive preambles associated with one SSB on one RO is 8.

After all SSBs are associated with the RO for one round, an SSB-RO mapping cycle is formed. One SSB-to-RO association period may include one or more SSB-RO mapping cycles. One SSB-to-RO association pattern period may include one or more SSB-RO association periods, mapping from the SSB to the RO is repeated by using the association pattern period as a cycle, and a maximum association pattern period is 160 ms.

Generally, the base station may send different SSBs by using different beams. A quantity of SSBs is configured by using a parameter ssb-PositionsInBurst. For example, for FR2, a maximum quantity of SSBs is 64. The terminal selects, based on strength of a received downlink beam or SSB, an RO associated with an SSB with a good signal/“RO or a combination of an RO and a preamble”, to send a Msg1. In this way, the network may determine, based on an RO of a received preamble/“a combination of an RO and a preamble”, the SSB selected by the terminal, and send a Msg2 on a downlink beam corresponding to the SSB, to ensure received quality of a downlink signal.

FIG. 2 is used as an example. A quantity of ROs for FDM at a moment is 8, and a quantity of actually transmitted SSBs is 4, namely, SSB #0, SSB #1, SSB #2, and SSB #3. Each SSB is associated with two ROs. If a terminal determines to transmit a PRACH/Msg1 on ROs corresponding to SSB #0, user equipment (UE) selects one RO from RO #0 and RO #1 to transmit the PRACH.

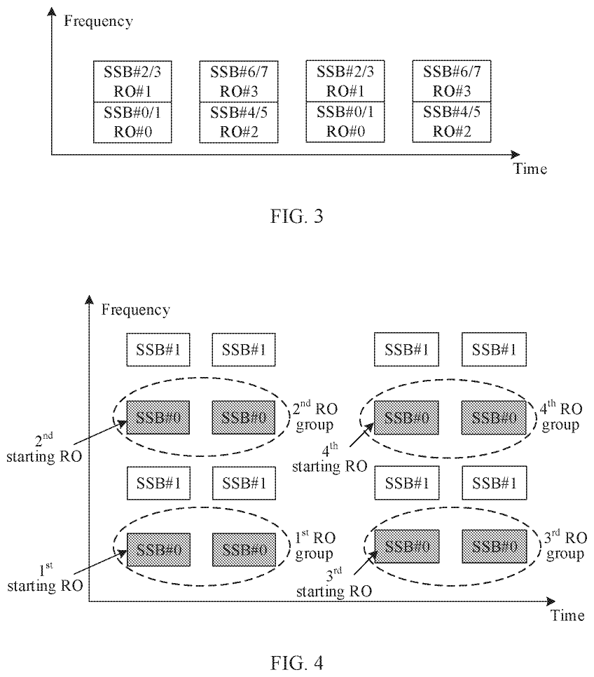

FIG. 3 is used as an example. A quantity of ROs for FDM at a moment is 2, and a quantity of actually transmitted SSBs is 8, namely, SSB #0, SSB #1, . . . , and SSB #7. Every two SSBs are associated with one RO. Each square in FIG. 3 corresponds to one RO instead of an SSB, and an SSB marked in the square refers to an SSB/SSBs associated with the RO. When a plurality of SSBs share one RO, preamble sets associated with the plurality of SSBs are different. In other words, a same preamble cannot belong to preamble sets associated with different SSBs. RO #0 in FIG. 3 is used as an example. RO #0 has a total of 60 preambles, where preambles indexed 0 to 29 are associated with SSB #0, and preambles indexed 30 to 59 are associated with SSB #1.

Before sending a PRACH, the terminal first selects an SSB whose Reference Signal Receiving Power (RSRP) is greater than a threshold based on reference signal receiving power of a received beam (SSB). If there are a plurality of SSBs whose RSRP is higher than the threshold, the terminal may select any SSB whose RSRP is higher than the threshold. When there is no SSB whose RSRP is higher than the threshold, the terminal may select an SSB based on an implementation.

Based on a network configuration, the terminal may obtain a correspondence between an SSB and an RO. After an SSB is selected, an RO corresponding to the selected SSB is used as an RO for sending the PRACH/Preamble/Msg1. If the selected SSB is associated with a plurality of ROs, the terminal may select one of the ROs to send the PRACH/Preamble/Msg1. For example, in the example shown in FIG. 2, it is assumed that the terminal selects SSB #1. The terminal may select one of RO #2 and RO #3 to send the PRACH/Msg1. In the example shown in FIG. 3, if the terminal selects SSB #1, the terminal may select, from ROs (RO #0 or RO #4) associated with SSB #1, an available RO closest to current time to send the PRACH/Msg1. On the selected RO, the terminal selects one preamble from a preamble set associated with the selected SSB to send the PRACH. As shown in FIG. 3, if one RO is associated with two SSBs, preambles in an available preamble set associated with SSBs on one RO are classified into two subsets, and each subset corresponds to one SSB. The terminal selects a preamble sequence in a preamble subset corresponding to the selected SSB to send the PRACH/Msg1.

Next, a process of determining an RO set when the PRACH is repeatedly sent is described. PRACH repeated sending is introduced in Rel-18 to enhance uplink coverage. For PRACH repeated sending, the terminal needs to repeatedly send a preamble on a plurality of ROs that are at different time domain locations and that are associated with a same SSB, and a repetition count may be {2,4,8}. After determining the PRACH repetition count, the terminal needs to determine an RO set, where a quantity of valid ROs in the RO set is equal to the PRACH repetition count. It is assumed that the PRACH repetition count is N1, and an RO group determining rule is as follows: First, a starting RO of the RO group is determined, and then remaining N1-1 ROs of the RO group are determined. Remaining N1-1 ROs of each RO group are ROs that are associated with a same SSB, are at a same frequency location, and are associated with a same preamble set as the starting RO. For example, in FIG. 4, it is assumed that the PRACH repetition count is 2. For SSB #0, it may be determined that the RO group is the following 1^{st} RO group, 2^{nd} RO group, 3^{rd} RO group, and 4^{th} RO group.

In a related technology, an association relationship between an SSB and an RO is not sufficiently flexible. For example, a PRACH resource is statically configured for a current cell by using RRC signaling, and cannot be dynamically changed. In a future communication system (such as a 6G communication system), a more flexible PRACH resource configuration may be performed, for example, some flexible PRACH resources that can be dynamically activated or deactivated are additionally configured based on a statically configured PRACH resource. Alternatively, some flexible PRACH resources may be additionally configured for a specific type of terminal for use. However, for the additionally configured flexible PRACH resources, how to associate the additionally configured flexible PRACH resources with an SSB is not configured.

In view of this, embodiments of this application provide a communication method, a terminal, and a network-side device to flexibly configure an association relationship between an SSB and a PRACH resource. For example, the embodiments of this application provide a communication method to configure an association between at least one synchronization signal block (SSB) and a flexible PRACH resource, thereby flexibly configuring an association relationship between an SSB and the flexible PRACH resource, and helping implement an association between the flexible PRACH resource and the SSB.

A communication method provided in embodiments of this application is described in detail below with reference to the accompanying drawing by using some embodiments and application scenarios thereof.

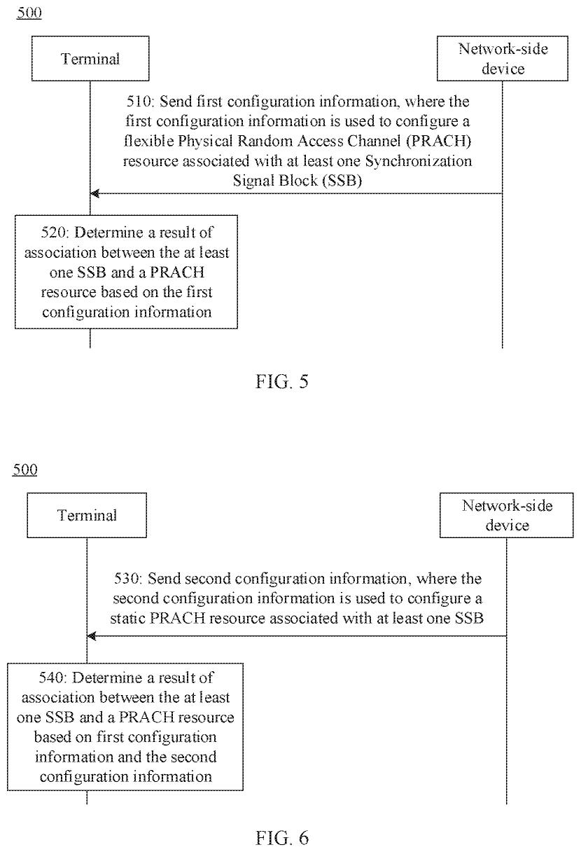

FIG. 5 is a schematic interaction diagram of a communication method according to an embodiment of this application. As shown in FIG. 5, the communication method includes at least the following steps 510 and 520.

510: A network-side device sends first configuration information to a terminal, where the first configuration information is used to configure a flexible physical random access channel (PRACH) resource associated with at least one synchronization signal block (SSB). Correspondingly, the terminal receives the first configuration information from the network-side device.

In this embodiment of this application, a Synchronization Channel Block (SSB), namely, a synchronization signal/physical broadcast channel block (SS/PBCH block, SSB), may be any module that includes at least one of a synchronization signal, a broadcast signal, a broadcast channel (PBCH), or another system message downlink broadcast channel.

In this embodiment of this application, a PRACH resource includes a PRACH transmission occasion, which is also referred to as a PRACH Occasion, and is referred to as an RO for short. The RO includes at least one preamble. In some other embodiments, the PRACH resource includes a preamble.

In this embodiment of this application, the flexible PRACH resource refers to a PRACH resource that can be flexibly activated and deactivated and that is additionally dynamically configured, compared with a statically configured PRACH resource in a related technology. For example, the flexible PRACH resource may include a flexible RO or a preamble on the flexible RO. Alternatively, compared with the PRACH resource configured in the related technology, the flexible PRACH resource is a PRACH resource in different frequency bands, or a PRACH resource for different service types, or a PRACH resource for different terminal types. This is not limited.

One SSB may be associated with at least one RO in the flexible PRACH resource, or one RO in the flexible PRACH resource may be associated with at least one SSB, or one SSB may be associated with all or a part of preambles on the flexible PRACH resource. This is not limited in embodiments of this application.

520: The terminal determines a result of association between the at least one SSB and the PRACH resource based on the first configuration information. The result of association between the at least one SSB and the PRACH resource may include the flexible PRACH resource associated with the at least one SSB.

Therefore, in this embodiment of this application, the network-side device sends the first configuration information to the terminal, so that the terminal may determine the result of association between the at least one SSB and the flexible PRACH resource based on the first configuration information, to configure the association between the at least one SSB and the flexible PRACH resource, thereby flexibly configuring an association relationship between an SSB and the PRACH resource.

In some embodiments, the first configuration information includes at least one of an SSB parameter, a PRACH resource set, or an association relationship between an SSB and the flexible PRACH resource.

For example, the SSB parameter includes at least one of the following:
a maximum quantity of SSBs, a quantity of SSBs used by a current cell, at least one SSB used by the current cell, a quantity of SSBs associated with the flexible PRACH resource, or the at least one SSB associated with the flexible PRACH resource.

The at least one SSB associated with the flexible PRACH resource may be all or a part of the at least one SSB used by the current cell. This is not limited in this application. In other words, all or a part of the at least one SSB used by the current cell may be configured to be associated with the flexible PRACH resource (that is, the flexible PRACH resource is used).

For example, when the quantity of SSBs used by the current cell is

$${N}_{TX}^{SSB} ,$$

### SSBs in the

$${N}_{TX}^{SSB}$$

SSBs may be associated with the flexible PRACH resource. N1 is a positive integer less than or equal to

$${N}_{TX}^{SSB} .$$

Optionally, N1 may be configured by a network or specified in a protocol. Optionally, it may be indicated based on a predefined rule (such as a network indication or a protocol specification) that in all currently available SSBs, first N1 SSBs are associated with the flexible PRACH resource, or last N1 SSBs are associated with the flexible PRACH resource, or an odd number of SSBs are associated with the flexible PRACH resource, or an even number of SSBs are associated with the flexible PRACH resource. This is not limited in this application.

In a specific example, the current cell uses eight SSBs, which are respectively {SSB #0, SSB #1, SSB #2, SSB #3, SSB #4, SSB #5, SSB #6, and SSB #7}. For a configured flexible PRACH resource set, such as a flexible RO set #0, an association result may be determined with all the SSBs. Alternatively, the flexible RO set #0 may be used to determine an association result with only specific N1 SSBs. Optionally, the N1 SSBs may be first four SSBs in the eight SSBs. N1 is a positive integer less than or equal to 8.

Optionally, the first configuration information may further include bitmap information, and the bitmap information indicates the at least one SSB associated with the flexible PRACH resource. For example, the bitmap information may indicate the specific N1 SSBs in the

$${N}_{TX}^{SSB}$$

SSBs. For example, 1 may indicate that the flexible PRACH resource is associated with a corresponding SSB, and 0 may indicate that the flexible PRACH resource is not associated with the corresponding SSB. In this case, the bitmap information [10101010] indicates that the odd number of SSBs are associated with the flexible PRACH resource.

For example, the PRACH resource set refers to a currently available PRACH resource set, including at least one of an RO resource or a Preamble resource.

For example, the association relationship between the SSB and the flexible PRACH resource is a mapping relationship between the SSB and the flexible PRACH resource. Optionally, the association relationship between the SSB and the flexible PRACH resource may include at least one of a quantity of consecutive ROs associated with one SSB, a quantity of SSBs associated with each RO, or a quantity of preambles associated with each SSB on one RO.

In some embodiments, the terminal may further receive a first activation signal from the network-side device, where the first activation signal is used to activate the flexible PRACH resource. Correspondingly, the network-side device sends the first activation signal to the terminal.

Specifically, the configured flexible PRACH resource may be inactive by default. In this case, the flexible PRACH resource may be activated for use. Specifically, the network-side device may activate the configured flexible PRACH resource by sending the first activation signal to the terminal.

In an implementable, the network-side device may send signaling to the terminal, where the signaling indicates the first activation signal, and the signaling may include at least one of Radio Resource Control (RRC), a Physical Downlink Control Channel (PDCCH), or a Medium Access Control (MAC) Control Element (CE).

Optionally, the configured flexible PRACH resource may be activated by default. In this case, the flexible PRACH resource can be used without performing activation.

Optionally, the network-side device may send a deactivation signal to the terminal, to indicate to deactivate the flexible PRACH resource. The terminal does not use the deactivated flexible PRACH resource to perform PRACH transmission.

In some embodiments, the terminal may further receive a second activation signal from the network-side device, where the second activation signal is used to activate a first part of the flexible PRACH resource. Correspondingly, the network-side device sends the second activation signal to the terminal.

Specifically, the configured flexible PRACH resource is inactive by default. In this case, the flexible PRACH resource may be partially activated for use. Specifically, the network-side device may activate the part of the configured flexible PRACH resource by sending the second activation signal to the terminal.

In some embodiments, the terminal may further receive a third activation signal from the network-side device, where the third activation signal is used to activate a second part of the flexible PRACH resource, and the second part of the flexible PRACH resource at least partially overlaps the first part of the flexible PRACH resource, or the second part of the flexible PRACH resource does not overlap the first part of the flexible PRACH resource. Correspondingly, the network-side device sends the third activation signal to the terminal.

Specifically, the configured flexible PRACH resource is inactive by default. In this case, the flexible PRACH resource may be partially activated a plurality of times for use. For example, an activation signal #1 (an example of the second activation signal) may activate a first part of the flexible PRACH resource set sub-set #1 (for example, first 25% of the resource), and an activation signal #2 (an example of the third activation signal) may activate a second part of the flexible PRACH resource set sub-set #2 (for example, first 25% of the resource).

In an implementable, the network-side device may send signaling to the terminal, where the signaling indicates at least one of the first activation signal or the second activation signal, and the signal may include at least one of RRC, a PDCCH, or a MAC CE.

Optionally, the first part of the flexible PRACH resource and the second part of the flexible PRACH resource correspond to different association relationships between SSBs and PRACH resources, or correspond to a same association relationship between SSBs and PRACH resources. This is not limited in this application.

For example, for the first part of the flexible PRACH resource and the second part of the flexible PRACH resource, association relationships between SSBs and PRACH resources corresponding to the first part of the flexible PRACH resource and the second part of the flexible PRACH resource may be configured together, for example, a same association relationship between SSBs and PRACH resources is used. For example, for the first part of the flexible PRACH resource and the second part of the flexible PRACH resource, a quantity of flexible ROs associated with each SSB may be configured as 1.

For example, for the first part of the flexible PRACH resource and the second part of the flexible PRACH resource, association relationships between SSBs and PRACH resources corresponding to the first part of the flexible PRACH resource and the second part of the flexible PRACH resource may be separately configured as different association relationships between SSBs and PRACH resources. For example, for the first part of the flexible PRACH resource, a quantity of flexible ROs associated with each SSB may be configured as 1; and for the second part of the flexible PRACH resource, a quantity of flexible ROs associated with each SSB may be configured as 2.

In some embodiments, when an overlapped resource of the first part of the flexible PRACH resource and the second part of the flexible PRACH resource includes a third part of the flexible PRACH resource, an SSB that is associated with the third part of the flexible PRACH resource and that is obtained based on an association relationship between an SSB and a PRACH resource corresponding to the first part of the flexible PRACH resource is the same as an SSB that is associated with the third part of the flexible PRACH resource and that is obtained based on an association relationship between an SSB and a PRACH resource corresponding to the second part of the flexible PRACH resource, and preamble sets associated with SSBs on the third part of the flexible PRACH resource are the same.

For example, the foregoing example is still used. When the activation signal #1 activates the first part of the flexible PRACH resource set sub-set #1 (for example, first 25% of the flexible PRACH resource) and the activation signal #2 activates the second part of the flexible PRACH resource set sub-set #2 (for example, first 50% of the flexible PRACH resource), an intersection set of the two activated resource sets is the first 25% of the resource. In this case, the first 25% of the resource is an example of the third part of the flexible PRACH resource. In this embodiment of this application, when the third activation signal activates the sub-set #2, an SSB that is associated with the third part of the flexible PRACH resource and that is obtained by the terminal based on an association relationship between an SSB and a PRACH resource corresponding to the sub-set #1 is the same as an SSB that is associated with the third part of the flexible PRACH resource and that is obtained based on an association relationship between an SSB and a PRACH resource corresponding to the sub-set #2, and preamble sets associated with this part of SSBs on an overlapped PRACH resource are the same. In other words, after the activation signal #1 activates the sub-set #1, when the activation signal #2 activates the sub-set #2, a result of association between the SSB of the third part of the flexible PRACH resource and the PRACH resource does not change, that is, the SSB corresponding to the third part of the flexible PRACH resource may be uniquely determined, and a preamble set associated with the SSB on the third part of the flexible PRACH resource remains unchanged.

In a possible case, when the network-side device sends the second activation signal and the third activation signal, some terminals may receive only one activation signal, and another activation signal is lost. For example, when the network-side device successively sends the activation signal #1 to activate the sub-set #1 (for example, the first 25% of the flexible PRACH resource) and the activation signal #2 to activate the sub-set #2 (for example, the first 50% of the flexible PRACH resource), a terminal that does not correctly decode the activation signal #2 considers that only the first 25% of the flexible PRACH resource is activated, and another terminal considers that the first 50% of the flexible PRACH resource is activated. When two terminals send the PRACH by using the first 25% of the flexible PRACH resource that belongs to the intersection set, because a result of association between the SSB of the first 25% of the flexible PRACH resource and the PRACH resource does not change, the SSB corresponding to the first 25% of the flexible PRACH resource may be uniquely determined, and a preamble set associated with the SSB on the first 25% of the flexible PRACH resource remains unchanged. Therefore, the network-side device can uniquely determine the SSB corresponding to the first 25% of the flexible PRACH resource, thereby improving reliability of PRACH transmission.

In some embodiments, a plurality of association relationships between SSBs and the flexible PRACH resource or a part of the flexible PRACH resource may be further configured. For example, the association relationships may be configured by a network or specified in a protocol. This is not limited in this application.

In some embodiments, when the plurality of association relationships between SSBs and the flexible PRACH resource or a part of the flexible PRACH resource, the network device may further send a fourth activation signal to the terminal, where the fourth activation signal is used to activate a currently used association relationship.

In an implementable, the network-side device may send signaling to the terminal, where the signaling indicates the fourth activation signal, and the signal may include at least one of RRC, a PDCCH, or a MAC CE.

In some embodiments, referring to FIG. 6, the method 500 may further include steps 530 and 540.

530: The network-side device sends second configuration information to the terminal, where the second configuration information is used to configure a static PRACH resource associated with the at least one SSB. Correspondingly, the terminal receives the second configuration information from the network-side device.

For example, the static PRACH resource may include a static RO or a preamble on the static RO. This is not limited. One SSB may be associated with at least one RO, or one RO may be associated with at least one SSB, or one SSB may be associated with all or a part of preambles on one RO. This is not limited in embodiments of this application.

The at least one SSB associated with the static PRACH resource may be all or a part of the at least one SSB used by the current cell. This is not limited in this application. In other words, all or a part of the at least one SSB used by the current cell may be configured to be associated with the static PRACH resource (that is, the static PRACH resource is used).

Optionally, the at least one SSB associated with the flexible PRACH resource may be the same as, partially the same as, or completely different from the at least one SSB associated with the static PRACH resource. This is not limited in this application. For example, the quantity of SSBs used by the current cell is

$${N}_{TX}^{SSB} ,$$

### and N2 SSBs in the

$${N}_{TX}^{SSB}$$

SSBs are associated with the static PRACH resource. N2 is a positive integer less than or equal to

$${N}_{TX}^{SSB} .$$

Optionally, N2 may be configured by a network or specified in a protocol. Optionally, it may be indicated based on a predefined rule (such as a network indication or a protocol specification) that N2 SSBs in all currently available SSBs are associated with the flexible PRACH resource.

Optionally, the second configuration information may further include bitmap information, and the bitmap information indicates the at least one SSB associated with the static PRACH resource. Specifically, the bitmap information is similar to the bitmap information in the first configuration information. For details, refer to the foregoing description. Details are not described herein again.

Optionally, the PRACH resource set may further include at least one currently available static PRACH resource.

In some embodiments, the second configuration information includes an association relationship between an SSB and the static PRACH resource.

For example, the association relationship between the SSB and the static PRACH resource is a mapping relationship between the SSB and the static PRACH resource. Optionally, the association relationship between the SSB and the static PRACH resource may include at least one of a quantity of consecutive ROs in a static PRACH resource associated with one SSB, a quantity of SSBs associated with each RO, or a quantity of preambles associated with each SSB on one RO.

540: The terminal determines the result of association between the at least one SSB and the PRACH resource based on the first configuration information and the second configuration information.

Therefore, in this embodiment of this application, the network-side device sends the second configuration information to the terminal, so that the terminal may determine a result of association between the at least one SSB and the static PRACH resource based on the second configuration information, to configure the association between the at least one SSB and the static PRACH resource, thereby flexibly configuring an association relationship between an SSB and the PRACH resource.

In some embodiments, step 540 may specifically include:

The terminal performs mapping in a first PRACH resource set based on the at least one SSB, to obtain the result of association between the at least one SSB and the PRACH resource, where the first PRACH resource set includes at least one flexible PRACH resource set and at least one static PRACH resource set.

In other words, a result of association between an SSB and the PRACH resource may be determined for both the configured flexible PRACH resource and static PRACH resource. When the result of association between the SSB and the PRACH resource is determined, the flexible PRACH resource set and the static PRACH resource set may correspond to a same association relationship between SSBs and PRACH resources, or the flexible PRACH resource set and the static PRACH resource set correspond to different association relationships between SSBs and PRACH resources. This is not limited in embodiments of this application.

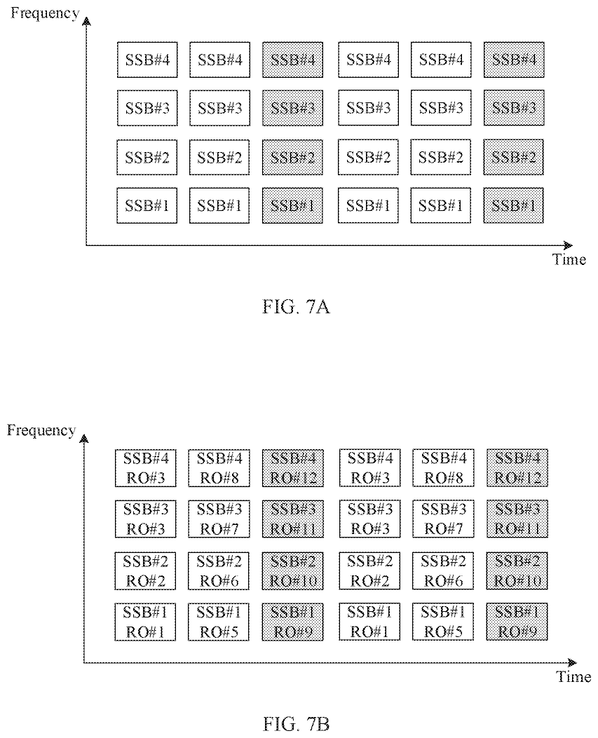

For example, FIG. 7A is a schematic diagram of determining a result of association between an SSB and a PRACH resource on a PRACH resource set for four SSBs. The PRACH resource set includes a static RO set (a static RO set #1) and a flexible RO set (a flexible RO set #2). For example, a white square represents a static RO, a gray square represents a flexible RO, the static RO set and the flexible RO set correspond to a same association relationship between an SSB and a PRACH resource, and each SSB is associated with one RO. In this case, a result of association between the SSB and the RO may be determined on the static RO set #1 and the flexible RO set #2 for the four SSBs. As shown in FIG. 7A, the static RO set #1 is sequentially associated with four SSBs, namely, SSB #1, SSB #2, SSB #3, and SSB #4, in ascending order of frequencies and in chronological order, and the flexible RO set #2 is sequentially associated with four SSBs, namely, SSB #1, SSB #2, SSB #3, and SSB #4, in ascending order of frequencies, and the like. Each square represents an RO instead of an SSB, and an SSB marked in the RO refers to an SSB associated with the RO.

In some embodiments, a first index may be sequentially determined for at least one SSB, and a first order may be determined for each RO in a first PRACH resource set (including a flexible PRACH resource set and a static PRACH resource set). Then, the at least one SSB is mapped to an RO in the first PRACH resource set based on the first index and the first order, to obtain a result of association between the at least one SSB and the PRACH resource.

For example, FIG. 7B is a schematic diagram of determining a result of association between an SSB and a PRACH resource on a PRACH resource set for four SSBs. The SSB and the PRACH resource set in FIG. 7B are the same as those in FIG. 7A. In FIG. 7B, indexes may be sequentially determined for the four SSBs, for example, SSB #1, SSB #2, SSB #3, and SSB #4 respectively, and an order is sequentially determined for each RO in the PRACH resource set, for example, RO #1/2/3/4/5/6/7/8/9/10/11/12. A result of association between the SSB and the RO may be determined on a static RO set #1 and a flexible RO set #2 for the four SSBs. As shown in FIG. 7B, the RO #1/2/3/4/5/6/7/8/9/10/11/12 are sequentially associated with the four SSBs, namely, SSB #1, SSB #2, SSB #3, and SSB #4, and the like. Each square represents an RO instead of an SSB, and an SSB marked in the RO refers to an SSB associated with the RO.

In some embodiments, the terminal may further determine at least one of a first mapping cycle, a first association period, or a first association pattern period, where the first mapping cycle is a cycle in which the at least one SSB is associated with the first PRACH resource set for one round, the first association period includes at least one first mapping cycle, and the first association pattern period includes at least one first association period.

Herein, the first mapping cycle, the first association period, or the first association pattern period are common values of time periods in which different types of PRACH resources are associated with the at least one SSB. For example, as shown in FIG. 7A or FIG. 7B, the first mapping cycle is a cycle in which four SSBs are associated for one round.

Optionally, the first association pattern period is a period in which the association relationship between the at least one SSB and the RO forms a repeatable pattern. Optionally, the first association pattern period does not exceed maximum time specified in a protocol.

Optionally, the terminal may further determine a first time window based on at least one of the first mapping cycle, the first association period, or the first association pattern period, where the first time window is an integer multiple of the first mapping cycle, the first association period, or the first association pattern period. Then, the terminal may send a signal to the network-side device in the first time window based on the result of association between the at least one SSB and the PRACH resource. For example, the signal may include a PRACH.

In other words, when results of association between different types of PRACH resources and the SSB are determined together, the different types of PRACH resources may be used to jointly determine a common first time window, and a corresponding PRACH resource is selected in the common first time window to send a signal to the network-side device. The terminal is set to send the signal in the first time window, so that it can be ensured that there are sufficient PRACH resources in the window for the terminal to select to send the signal.

In some other embodiments, the first time window may include at least one first mapping cycle, first association period, or first association pattern period. In this case, the first time window may not need to be an integer multiple of the first mapping cycle, the first association period, or the first association pattern period, provided that there are sufficient PRACH resources in the window for selection.

In some embodiments, the foregoing step 540 may include:

The terminal performs, in a second PRACH resource set, mapping from an SSB to a PRACH resource based on an association relationship that is between the SSB and the PRACH resource and that corresponds to the second PRACH resource set, to obtain the result of association between the at least one SSB and the PRACH resource, where the second PRACH resource set includes at least one flexible PRACH resource set.

The terminal performs, in a third PRACH resource set, mapping from an SSB to a PRACH resource based on an association relationship that is between the SSB and the PRACH resource and that corresponds to the third PRACH resource set, to obtain the result of association between the at least one SSB and the PRACH resource, where the third PRACH resource set includes at least one static PRACH resource set.

In other words, a result of association between an SSB and the PRACH resource may be determined for each of the configured flexible PRACH resource and static PRACH resource. An association relationship between the SSB and the PRACH resource corresponding to the flexible PRACH resource set and an association relationship between the SSB and the PRACH resource corresponding to the static PRACH resource set may be mutually independent, and the flexible PRACH resource set and the static PRACH resource set may correspond to a same association relationship between the SSB and the PRACH resource or different association relationships between the SSB and the PRACH resource. This is not limited in this application.

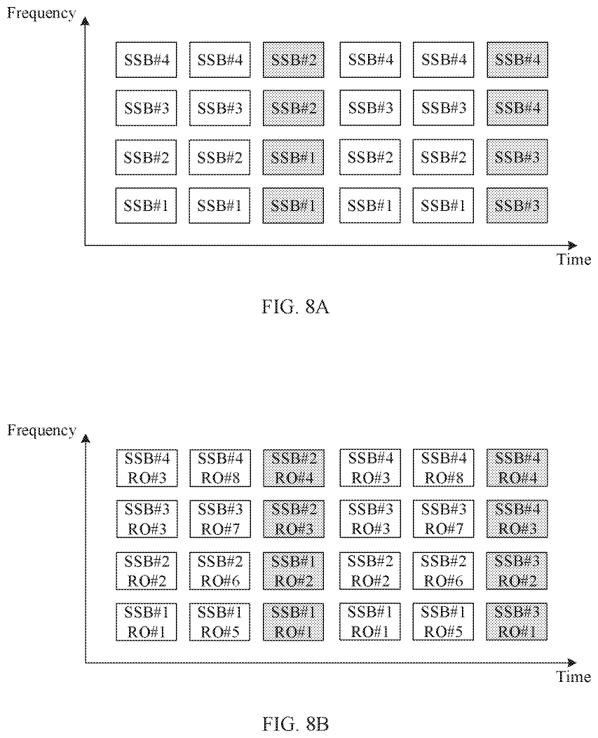

For example, FIG. 8A is a schematic diagram of determining a result of association between an SSB and a PRACH resource on a PRACH resource set for four SSBs. The PRACH resource set includes a static RO set (a static RO set #1) and a flexible RO set (a flexible RO set #2). For example, a white square represents a static RO, and a gray square represents a flexible RO. Each SSB in the static RO set #1 is associated with one RO, and each SSB in the flexible RO set #2 is associated with two ROs. In this case, a result of association between the SSB and the RO may be separately determined on the static RO set #1 and the flexible RO set #2 for the four SSBs. As shown in FIG. 8A, the static RO set #1 is sequentially associated with four SSBs (one SSB is associated with one RO), namely, SSB #1, SSB #2, SSB #3, and SSB #4, in ascending order of frequencies and in chronological order, and the flexible RO set #2 is sequentially associated with four SSBs (one SSB is associated with two ROs), namely, SSB #1, SSB #2, SSB #3, and SSB #4, in ascending order of frequencies, and the like. Each square represents an RO instead of an SSB, and an SSB marked in the RO refers to an SSB associated with the RO.

In some embodiments, a first index may be sequentially determined for at least one SSB, a first order may be determined for each RO in a second PRACH resource set (for example, a flexible PRACH resource set), and a second order may be determined for each RO in a third PRACH resource set (for example, a static PRACH resource set). Then, the at least one SSB is mapped to an RO in the second PRACH resource set based on the first index and the first order, and the at least one SSB is mapped to an RO in the third PRACH resource set based on the first index and the second order, to obtain a result of association between the at least one SSB and a PRACH resource.

For example, FIG. 8B is a schematic diagram of determining a result of association between an SSB and a PRACH resource on a PRACH resource set for four SSBs. The SSB and the PRACH resource set in FIG. 8B are the same as those in FIG. 8A. In FIG. 8B, indexes may be sequentially determined for the four SSBs, for example, SSB #1, SSB #2, SSB #3, and SSB #4 respectively, an order is sequentially determined for each RO in a static RO set #1, for example, RO #1/2/3/4/5/6/7/8, and an order is sequentially determined for each RO in a flexible RO set #2, for example, RO #1/2/3/4. A result of association between the SSB and the RO is separately determined on the static RO set #1 and the flexible RO set #2 for the four SSBs. As shown in FIG. 8B, the RO #1/2/3/4/5/6/7/8 in the static RO set #1 are sequentially associated with the four SSBs (one SSB is associated with one RO), namely, SSB #1, SSB #2, SSB #3, and SSB #4, and the like. The RO #1/2/3/4 in the flexible RO set #2 are sequentially associated with four SSBs (one SSB is associated with two ROs), namely, SSB #1, SSB #2, SSB #3, and SSB #4, and the like. Each square represents an RO instead of an SSB, and an SSB marked in the RO refers to an SSB associated with the RO.

In some embodiments, the terminal may further determine at least one of a second mapping cycle, a second association period, or a second association pattern period, where the second mapping cycle is a cycle in which the at least one SSB is associated with the second PRACH resource set for one round, the second association period includes at least one second mapping cycle, and the second association pattern period includes at least one second association period; and determine at least one of a third mapping cycle, a third association period, or a third association pattern period, where the third mapping cycle is a cycle in which the at least one SSB is associated with the third PRACH resource set for one round, the third association period includes at least one third mapping cycle, and the third association pattern period includes at least one third association period.

Specifically, when different types of PRACH resources are separately used to determine an association result with the SSB, SSBs of the different types of PRACH resources and various time periods associated with an RO are separately determined. For example, in FIG. 8A and FIG. 8B, for the static RO set #1, a mapping cycle from the SSB to the RO is a cycle in which all the four SSBs are associated for one round in the static RO set #1. For the flexible RO set #2, a mapping cycle from the SSB to the RO is a cycle in which all the four SSBs are associated for one round in the flexible RO set #2.

Optionally, the second association pattern period and the third association pattern period each are a period in which the association relationship between the at least one SSB and the RO forms a repeatable pattern. Optionally, the second association pattern period and the third association pattern period each do not exceed maximum time specified in a protocol.

Optionally, the terminal may further determine a second time window based on at least one of the second mapping cycle, the second association period, or the second association pattern period; and determine a third time window based on at least one of the third mapping cycle, the third association period, or the third association pattern period. Then, the terminal may send a signal to the network device in the second time window based on a result of association between the at least one SSB and the flexible PRACH resource; or send a signal to the network-side device in the third time window based on a result of association between the at least one SSB and the static PRACH resource. The terminal is set to send the signal in the second time window or the third time window, so that it can be ensured that there are sufficient PRACH resources in the window for the terminal to select to send the signal. For example, the signal may include a PRACH.

In other words, when results of association between different types of PRACH resources and the SSB are separately determined, the different types of PRACH resources may be used to separately determine different time windows, for example, the second time window and the third time window, and a corresponding PRACH resource is selected in a corresponding time window to send the signal to the network-side device. The terminal is set to send the signal in the corresponding time window, so that it can be ensured that there are sufficient PRACH resources in the window for the terminal to select to send the signal.

In some other embodiments, the second time window may include at least one second mapping cycle, second association period, or second association pattern period, and the third time window may include at least one third mapping cycle, third association period, or third association pattern period. In this case, the second time window or the third time window may not need to be an integer multiple of the corresponding mapping cycle, association period, or association pattern period, provided that there are sufficient PRACH resources in the window for selection.

In some embodiments, the terminal may further determine a fourth time window based on at least one of a maximum mapping cycle in the second mapping cycle and the third mapping cycle, a maximum association period in the second association period and the third association period, or a maximum association pattern period in the second association pattern period and the third association pattern period. Then, the terminal sends a signal to the network device in the fourth time window based on a result of association between the at least one SSB and the flexible PRACH resource; or send a signal to the network device in the fourth time window based on a result of association between the at least one SSB and the static PRACH resource.

In other words, when results of association between different types of PRACH resources and the SSB are separately determined, the different types of PRACH resources may be used to determine a same time window. The same time window may be determined based on a maximum time period selected from various time periods in which the SSB is associated with various PRACH resource sets, for example, may be an integer multiple of the maximum mapping cycle, the maximum association period, or the maximum association pattern period, or may include the maximum mapping cycle, the maximum association period, or the maximum association pattern period (instead of the integer multiple of the maximum mapping cycle, the maximum association period, or the maximum association pattern period). This is not limited in embodiments of this application. The terminal is set to send the signal in the corresponding time window, so that it can be ensured that there are sufficient PRACH resources in the window for the terminal to select to send the signal.

In some embodiments, the flexible PRACH resource and the static PRACH resource meet at least one of the following:
the flexible PRACH resource is associated with the static PRACH resource with a same frequency domain location and a closest time domain distance;
the flexible PRACH resource is associated with the static PRACH resource with a same time domain location and a closest frequency domain distance;
an SSB associated with the flexible PRACH resource is the same as an SSB associated with a static PRACH resource associated with the flexible PRACH resource; or
an SSB associated with the flexible PRACH resource is a subsequent SSB of an SSB associated with a static PRACH resource associated with the flexible PRACH resource.

For example, the subsequent SSB of the SSB refers to an SSB corresponding to a next index. For example, if a current SSB is SSB #1 (whose index is 1), the subsequent SSB is SSB #2 (whose index is 2). For an SSB corresponding to a last index in a group of SSBs, a subsequent index of the SSB is an SSB corresponding to a first index in the group of SSBs. For example, if the current SSB is {SSB #1, SSB #2, SSB #3, SSB #4}, a subsequent SSB of SSB #4 is SSB #1.

In this embodiment of this application, a quantity of PRACH resources corresponding to a specific SSB can be increased by configuring the SSB associated with the flexible PRACH resource to be the same as the SSB associated with the static PRACH resource associated with the flexible PRACH resource. This helps meet a requirement of the specific SSB on the PRACH resource.

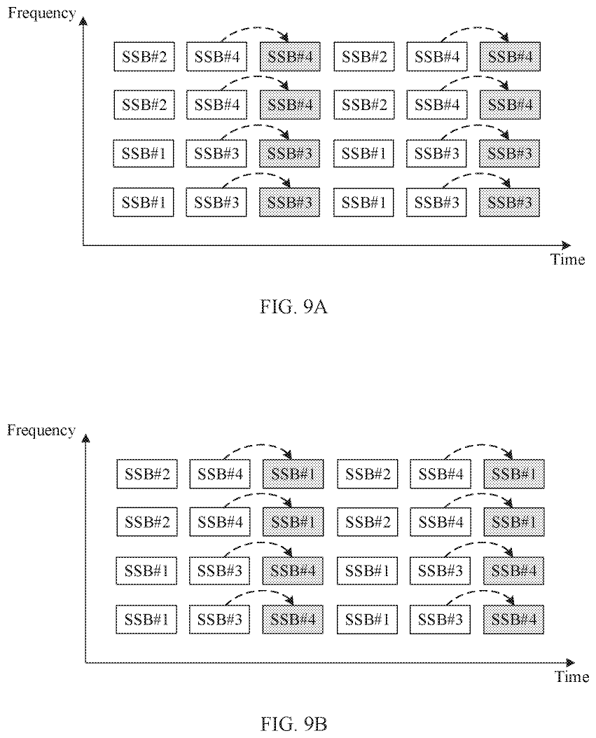

For example, FIG. 9A is a schematic diagram of determining a result of association between an SSB and a PRACH resource on a PRACH resource set for four SSBs. The PRACH resource set includes a static RO set (a static RO set #1) and a flexible RO set (a flexible RO set #2). For example, a white square represents a static RO, and a gray square represents a flexible RO. Each SSB in the static RO set #1 is associated with two ROs. ROs with a same frequency domain location and a closest time domain distance in the flexible RO set #2 and the static RO set #1 are associated, as shown by a dashed arrow in FIG. 9A. In this case, an SSB associated with a flexible RO in the flexible RO set #2 is the same as an SSB associated with a static RO associated with the flexible RO in the static RO set #1. Each square represents an RO instead of an SSB, and an SSB marked in the RO refers to an SSB associated with the RO.

For another example, FIG. 9B is a schematic diagram of determining a result of association between an SSB and a PRACH resource on a PRACH resource set for four SSBs. Unlike FIG. 9A, in FIG. 9B, an SSB associated with a flexible RO in the flexible RO set #2 is a subsequent SSB of an SSB associated with a static RO associated with the flexible RO in the static RO set #1. For example, when the static RO in the static RO set #1 is associated with SSB #3, the flexible RO associated with the static RO in the flexible RO set #2 is associated with a subsequent SSB of SSB #3, namely, SSB #4. For another example, when the static RO in the static RO set #1 is associated with SSB #4, the flexible RO associated with the static RO in the flexible RO set #2 is associated with a subsequent SSB of SSB #4, namely, SSB #1.

In some embodiments, the network-side device may further send signaling to the terminal, where the signaling is used to configure an association relationship between a PRACH resource and an SSB corresponding to at least a part of the flexible PRACH resource. For example, the signaling may include but is not limited to at least one of RRC, a PDCCH, or a MAC CE.

For example, when the at least a part of the flexible PRACH resource is dynamically activated, the network-side device may send the signaling to the terminal, to reconfigure an association relationship between the flexible PRACH resource and the SSB corresponding to the at least a part of the flexible PRACH resource. For another example, the network-side device may send the signaling to the terminal, to reconfigure an association relationship between an SSB corresponding to the static PRACH resource and the static PRACH resource.

Therefore, in this embodiment of this application, the association relationship between the PRACH resource and the SSB corresponding to the at least a part of the flexible PRACH resource is activated, so that the association relationship between the PRACH resource and the SSB corresponding to the at least a part of the flexible PRACH resource can be dynamically indicated to update. This helps flexibly associate the SSB with the flexible PRACH resource.

The communication method provided in this embodiment of this application may be performed by a communication apparatus. In embodiments of this application, an example in which a communication apparatus performs the communication method is used to describe the communication apparatus provided in embodiments of this application.

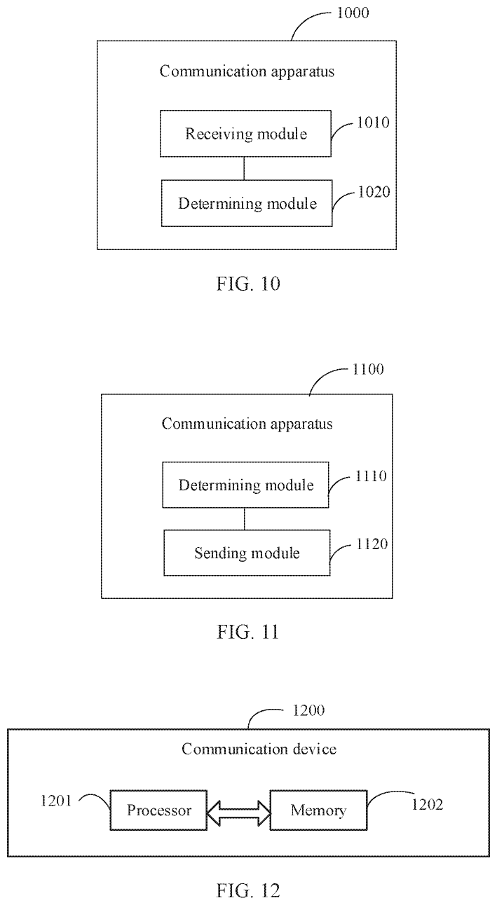

FIG. 10 is a schematic block diagram of a communication apparatus 1000 according to an embodiment of this application. For example, the communication apparatus 1000 may be a terminal. As shown in FIG. 10, the communication apparatus 1000 includes a receiving module 1010 and a determining module 1020.

The receiving module 1010 is configured to receive first configuration information from a network-side device, where the first configuration information is used to configure a flexible physical random access channel (PRACH) resource associated with at least one synchronization signal block (SSB).

The determining module 1020 is configured to determine a result of association between the at least one SSB and a PRACH resource based on the first configuration information.

In this embodiment of this application, the network-side device sends the first configuration information to the terminal, so that the terminal may determine a result of association between the at least one SSB and the flexible PRACH resource based on the first configuration information, to configure the association between the at least one SSB and the flexible PRACH resource, thereby flexibly configuring an association relationship between an SSB and the PRACH resource.

In some embodiments, the first configuration information includes at least one of an SSB parameter, a PRACH resource set, or an association relationship between an SSB and the flexible PRACH resource.

In some embodiments, the SSB parameter includes at least one of the following:
a maximum quantity of SSBs, a quantity of SSBs used by a current cell, at least one SSB used by the current cell, a quantity of SSBs associated with the flexible PRACH resource, or the at least one SSB associated with the flexible PRACH resource.

In some embodiments, the first configuration information further includes bitmap information, and the bitmap information indicates the at least one SSB associated with the flexible PRACH resource.

In some embodiments, the receiving module 1010 is further configured to:
receive a first activation signal from the network-side device, where the first activation signal is used to activate the flexible PRACH resource.

In some embodiments, the receiving module 1010 is further configured to:
receive a second activation signal from the network-side device, where the second activation signal is used to activate a first part of the flexible PRACH resource.

In some embodiments, the receiving module 1010 is further configured to:
receive a third activation signal from the network-side device, where the third activation signal is used to activate a second part of the flexible PRACH resource, and the second part of the flexible PRACH resource at least partially overlaps the first part of the flexible PRACH resource, or the second part of the flexible PRACH resource does not overlap the first part of the flexible PRACH resource.

In some embodiments, the first part of the flexible PRACH resource and the second part of the flexible PRACH resource correspond to different association relationships between SSBs and PRACH resources, or correspond to a same association relationship between SSBs and PRACH resources.

In some embodiments, when an overlapped resource of the first part of the flexible PRACH resource and the second part of the flexible PRACH resource includes a third part of the flexible PRACH resource, an SSB that is associated with the third part of the flexible PRACH resource and that is obtained based on an association relationship between an SSB and a PRACH resource corresponding to the first part of the flexible PRACH resource is the same as an SSB that is associated with the third part of the flexible PRACH resource and that is obtained based on an association relationship between an SSB and a PRACH resource corresponding to the second part of the flexible PRACH resource, and preamble sets associated with SSBs on the third part of the flexible PRACH resource are the same.

In some embodiments, the receiving module 1010 is further configured to:
receive second configuration information from the network-side device, where the second configuration information is used to configure a static PRACH resource associated with the at least one SSB.

The determining module 1020 is further configured to:
determine the result of association between the at least one SSB and the PRACH resource based on the first configuration information and the second configuration information.

In some embodiments, the second configuration information includes an association relationship between an SSB and the static PRACH resource.

In some embodiments, the determining module 1020 is specifically configured to:
perform mapping in a first PRACH resource set based on the at least one SSB, to obtain the result of association between the at least one SSB and the PRACH resource, where the first PRACH resource set includes at least one flexible PRACH resource set and at least one static PRACH resource set.

In some embodiments, the flexible PRACH resource set and the static PRACH resource set correspond to a same association relationship between SSBs and PRACH resources, or the flexible PRACH resource set and the static PRACH resource set correspond to different association relationships between SSBs and PRACH resources.

In some embodiments, the determining module 1020 is further configured to:
determine at least one of a first mapping cycle, a first association period, or a first association pattern period, where the first mapping cycle is a cycle in which the at least one SSB is associated with the first PRACH resource set for one round, the first association period includes at least one first mapping cycle, and the first association pattern period includes at least one first association period.

In some embodiments, the determining module 1020 is further configured to:
determine a first time window based on at least one of the first mapping cycle, the first association period, or the first association pattern period, where the first time window is an integer multiple of the first mapping cycle, the first association period, or the first association pattern period.

The communication apparatus 1000 further includes a sending module, configured to send a signal to the network-side device in the first time window based on the result of association between the at least one SSB and the PRACH resource.

In some embodiments, the determining module 1020 is specifically configured to:
perform, in a second PRACH resource set, mapping from an SSB to a PRACH resource based on an association relationship that is between the SSB and the PRACH resource and that corresponds to the second PRACH resource set, to obtain the result of association between the at least one SSB and the PRACH resource, where the second PRACH resource set includes at least one flexible PRACH resource set; and
perform, in a third PRACH resource set, mapping from an SSB to a PRACH resource based on an association relationship that is between the SSB and the PRACH resource and that corresponds to the third PRACH resource set, to obtain the result of association between the at least one SSB and the PRACH resource, where the third PRACH resource set includes at least one static PRACH resource set.

In some embodiments, the determining module 1020 is further configured to:
determine at least one of a second mapping cycle, a second association period, or a second association pattern period, where the second mapping cycle is a cycle in which the at least one SSB is associated with the second PRACH resource set for one round, the second association period includes at least one second mapping cycle, and the second association pattern period includes at least one second association period; and
determine at least one of a third mapping cycle, a third association period, or a third association pattern period, where the third mapping cycle is a cycle in which the at least one SSB is associated with the third PRACH resource set for one round, the third association period includes at least one third mapping cycle, and the third association pattern period includes at least one third association period.

In some embodiments, the determining module 1020 is further configured to:
determine a second time window based on at least one of the second mapping cycle, the second association period, or the second association pattern period; and determine a third time window based on at least one of the third mapping cycle, the third association period, or the third association pattern period.

The sending module is further configured to: send a signal to the network device in the second time window based on a result of association between the at least one SSB and the flexible PRACH resource; or send a signal to the network-side device in the third time window based on a result of association between the at least one SSB and the static PRACH resource.

In some embodiments, the determining module 1020 is further configured to:
determine a fourth time window based on at least one of a maximum mapping cycle in the second mapping cycle and the third mapping cycle, a maximum association period in the second association period and the third association period, or a maximum association pattern period in the second association pattern period and the third association pattern period.

The sending module is further configured to: send a signal to the network device in the fourth time window based on a result of association between the at least one SSB and the flexible PRACH resource; or send a signal to the network device in the fourth time window based on a result of association between the at least one SSB and the static PRACH resource.

In some embodiments, the flexible PRACH resource and the static PRACH resource meet at least one of the following:
the flexible PRACH resource is associated with the static PRACH resource with a same frequency domain location and a closest time domain distance;
the flexible PRACH resource is associated with the static PRACH resource with a same time domain location and a closest frequency domain distance;
an SSB associated with the flexible PRACH resource is the same as an SSB associated with a static PRACH resource associated with the flexible PRACH resource; or
an SSB associated with the flexible PRACH resource is a subsequent SSB of an SSB associated with a static PRACH resource associated with the flexible PRACH resource.

In some embodiments, the receiving module 1010 is further configured to:
receive signaling from the network-side device, where the signaling is used to configure an association relationship between a PRACH resource and an SSB corresponding to at least a part of the flexible PRACH resource.

The communication apparatus 1000 in this embodiment of this application may be an electronic device, for example, an electronic device with an operating system, or may be a component such as an integrated circuit or a chip in the electronic device. The electronic device may be a terminal, or may be a device other than the terminal. For example, the terminal may include but is not limited to the foregoing listed types of the terminal 11. The another device may be a server, a Network Attached Storage (NAS), or the like. This is not specifically limited in this embodiment of this application.

The communication apparatus 1000 provided in this embodiment of this application can implement processes implemented by the terminal in the method embodiment of FIG. 5 or FIG. 6, and achieve a same technical effect. To avoid repetition, details are not described herein again.

FIG. 11 is a schematic block diagram of a communication apparatus 1100 according to an embodiment of this application. For example, the communication apparatus 1100 may be a network-side device. As shown in FIG. 11, the communication apparatus 1100 includes a determining module 1110 and a sending module 1120.

The determining module 1110 is configured to determine first configuration information, where the first configuration information is used to configure a flexible physical random access channel (PRACH) resource associated with at least one synchronization signal block (SSB).

The sending module 1120 is configured to send the first information to a terminal.

In this embodiment of this application, the network-side device sends the first configuration information to the terminal, so that the terminal may determine a result of association between the at least one SSB and the flexible PRACH resource based on the first configuration information, to configure the association between the at least one SSB and the flexible PRACH resource, thereby flexibly configuring an association relationship between an SSB and the PRACH resource.

In some embodiments, the first configuration information includes at least one of an SSB parameter, a PRACH resource set, or an association relationship between an SSB and the flexible PRACH resource.

In some embodiments, the SSB parameter includes at least one of the following:
a maximum quantity of SSBs, a quantity of SSBs used by a current cell, at least one SSB used by the current cell, a quantity of SSBs associated with the flexible PRACH resource, or the at least one SSB associated with the flexible PRACH resource.

In some embodiments, the first configuration information further includes bitmap information, and the bitmap information indicates the at least one SSB associated with the flexible PRACH resource.

In some embodiments, the sending module 1120 is further configured to:
send a first activation signal to the terminal, where the first activation signal is used to activate the flexible PRACH resource.

In some embodiments, the sending module 1120 is further configured to:
send a second activation signal to the terminal, where the second activation signal is used to activate a first part of the flexible PRACH resource.

In some embodiments, the sending module 1120 is further configured to:
send a third activation signal to the terminal, where the third activation signal is used to activate a second part of the flexible PRACH resource, and the second part of the flexible PRACH resource at least partially overlaps the first part of the flexible PRACH resource, or the second part of the flexible PRACH resource does not overlap the first part of the flexible PRACH resource.

In some embodiments, the first part of the flexible PRACH resource and the second part of the flexible PRACH resource correspond to different association relationships between SSBs and PRACH resources, or correspond to a same association relationship between SSBs and PRACH resources.

In some embodiments, when an overlapped resource of the first part of the flexible PRACH resource and the second part of the flexible PRACH resource includes a third part of the flexible PRACH resource, an SSB that is associated with the third part of the flexible PRACH resource and that is obtained based on an association relationship between an SSB and a PRACH resource corresponding to the first part of the flexible PRACH resource is the same as an SSB that is associated with the third part of the flexible PRACH resource and that is obtained based on an association relationship between an SSB and a PRACH resource corresponding to the second part of the flexible PRACH resource, and preamble sets associated with SSBs on the third part of the flexible PRACH resource are the same.

In some embodiments, the sending module 1120 is further configured to:
send second configuration information to the terminal, where the second configuration information is used to configure a static PRACH resource associated with the at least one SSB.

In some embodiments, the second configuration information includes an association relationship between an SSB and the static PRACH resource.

In some embodiments, the flexible PRACH resource and the static PRACH resource meet at least one of the following:
the flexible PRACH resource is associated with the static PRACH resource with a same frequency domain location and a closest time domain distance;
the flexible PRACH resource is associated with the static PRACH resource with a same time domain location and a closest frequency domain distance;
an SSB associated with the flexible PRACH resource is the same as an SSB associated with a static PRACH resource associated with the flexible PRACH resource; or
an SSB associated with the flexible PRACH resource is a subsequent SSB of an SSB associated with a static PRACH resource associated with the flexible PRACH resource.

In some embodiments, the sending module 1120 is further configured to:
send signaling to the terminal, where the signaling is used to configure an association relationship between a PRACH resource and an SSB corresponding to at least a part of the flexible PRACH resource.

The communication apparatus 1100 in this embodiment of this application may be an electronic device, for example, an electronic device with an operating system, or may be a component such as an integrated circuit or a chip in the electronic device. The electronic device may be a network-side device, or may be a device other than the network-side device. For example, the network-side device may include but is not limited to the types of the network-side device 12 listed above, and the another device may be a server, a Network Attached Storage (NAS), or the like. This is not specifically limited in embodiments of this application.

The communication apparatus 1100 provided in this embodiment of this application can implement processes implemented by the network-side device in the method embodiment of FIG. 5 or FIG. 6, and achieve a same technical effect. To avoid repetition, details are not described herein again.

As shown in FIG. 12, an embodiment of this application further provides a communication device 1200, including a processor 1201 and a memory 1202. The memory 1202 stores a program or instructions capable of running on the processor 1201. For example, when the communication device 1200 is a terminal, the program or the instructions are executed by the processor 1201 to implement the steps performed by the terminal in the foregoing communication method embodiments, and a same technical effect can be achieved. When the communication device 1200 is a network-side device, the program or the instructions are executed by the processor 1201 to implement the steps performed by the network-side device in the foregoing communication method embodiments, and a same technical effect can be achieved. To avoid repetition, details are not described herein again.

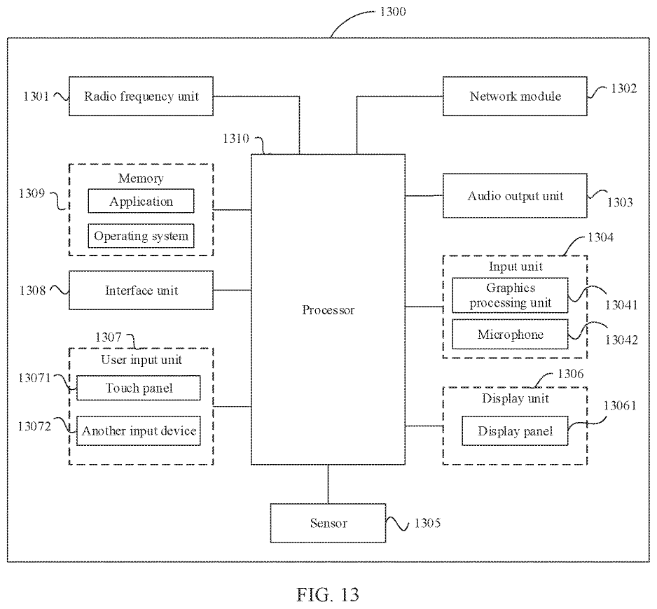

An embodiment of this application further provides a terminal, including a processor and a communication interface. The communication interface is coupled to the processor. The processor is configured to run a program or instructions to implement the steps performed by the terminal in the method embodiment shown in FIG. 5 or FIG. 6. The terminal embodiment corresponds to the foregoing method embodiment for the terminal side. Each implementation process and implementation of the foregoing method embodiment may be applied to the terminal embodiment, and a same technical effect can be achieved. Specifically, FIG. 13 is a schematic diagram of a hardware structure of a terminal for implementing an embodiment of this application.

The terminal 1300 includes but is not limited to at least some of the following components: a radio frequency unit 1301, a network module 1302, an audio output unit 1303, an input unit 1304, a sensor 1305, a display unit 1306, a user input unit 1307, an interface unit 1308, a memory 1309, a processor 1310, and the like.

A person skilled in the art may understand that the terminal 1300 may further include a power supply (for example, a battery) that supplies power to each component. The power supply may be logically connected to the processor 1310 by using a power management system, so as to implement functions such as charging management, discharging management, and power consumption management by using the power management system. The terminal structure shown in FIG. 13 constitutes no limitation on the terminal, and the terminal may include more or fewer components than those shown in the figure, or combine some components, or have different component arrangements.

It should be understood that in this embodiment of this application, the input unit 1304 may include a Graphics Processing Unit (GPU) 13041 and a microphone 13042. The graphics processing unit 13041 processes image data of a still picture or a video obtained by an image capture apparatus (for example, a camera) in a video capture mode or an image capture mode. The display unit 1306 may include a display panel 13061, and the display panel 13061 may be configured in a form of a liquid crystal display, an organic light-emitting diode, or the like. The user input unit 1307 includes at least one of a touch panel 13071 or another input device 13072. The touch panel 13071 is also referred to as a touchscreen. The touch panel 13071 may include two parts: a touch detection apparatus and a touch controller. The another input device 13072 may include but is not limited to a physical keyboard, a function key (for example, a volume control key or an on/off key), a trackball, a mouse, and a joystick. Details are not described herein.

In this embodiment of this application, after receiving downlink data from a network-side device, the radio frequency unit 1301 may transmit the downlink data to the processor 1310 for processing. In addition, the radio frequency unit 1301 may send uplink data to the network-side device. Generally, the radio frequency unit 1301 includes but is not limited to an antenna, an amplifier, a transceiver, a coupler, a low-noise amplifier, a duplexer, and the like.

The memory 1309 may be configured to store a software program or instructions and various types of data. The memory 1309 may mainly include a first storage area for storing a program or instructions and a second storage area for storing data. The first storage area may store an operating system, an application program or instructions required by at least one function (for example, a sound playing function or an image playing function), and the like. In addition, the memory 1309 may include a volatile memory or a nonvolatile memory. The nonvolatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1309 in this embodiment of this application includes but is not limited to these memories and any other suitable type of memory.

The processor 1310 may include one or more processing units. Optionally, the processor 1310 is integrated with an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1310.

The radio frequency unit 1301 is configured to receive first configuration information from a network-side device, where the first configuration information is used to configure a flexible physical random access channel (PRACH) resource associated with at least one synchronization signal block (SSB).

The processor 1310 is configured to determine a result of association between the at least one SSB and a PRACH resource based on the first configuration information.

In this embodiment of this application, the network-side device sends the first configuration information to the terminal, so that the terminal may determine a result of association between the at least one SSB and the flexible PRACH resource based on the first configuration information, to configure the association between the at least one SSB and the flexible PRACH resource, thereby flexibly configuring an association relationship between an SSB and the PRACH resource.

It may be understood that for implementation processes of the implementations mentioned in this embodiment, reference may be made to related descriptions in the method embodiment, and same or corresponding technical effects are achieved. To avoid repetition, details are not described herein again.

An embodiment of this application further provides a network-side device, including a processor and a communication interface. The communication interface is coupled to the processor. The processor is configured to run a program or instructions to implement the steps performed by the network-side device in the method embodiment shown in FIG. 5 or FIG. 6. The network-side device embodiment corresponds to the foregoing method embodiment for the network-side device. Each implementation process and implementation of the foregoing method embodiment may be applied to the network-side device embodiment, and a same technical effect can be achieved.

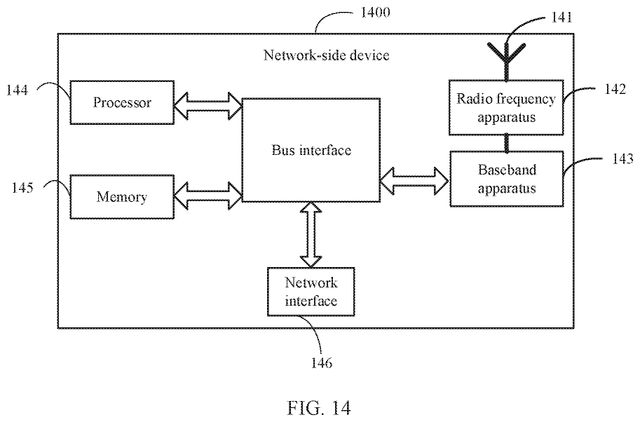

Specifically, an embodiment of this application further provides a network-side device. As shown in FIG. 14, the network-side device 1400 includes an antenna 141, a radio frequency apparatus 142, a baseband apparatus 143, a processor 144, and a memory 145. The antenna 141 is connected to the radio frequency apparatus 142. In an uplink direction, the radio frequency apparatus 142 receives information through the antenna 141, and sends the received information to the baseband apparatus 143 for processing. In a downlink direction, the baseband apparatus 143 processes to-be-sent information, and sends processed information to the radio frequency apparatus 142. After processing the received information, the radio frequency apparatus 142 sends processed information through the antenna 141.

The method performed by the network-side device in the foregoing embodiment may be implemented in the baseband apparatus 143. The baseband apparatus 143 includes a baseband processor.

For example, the baseband apparatus 143 may include at least one baseband board. A plurality of chips are disposed on the baseband board. As shown in FIG. 14, one of the chips is, for example, the baseband processor, and is connected to the memory 145 through a bus interface, to invoke a program in the memory 145 to perform the operation of the network device shown in the foregoing method embodiment.

The network-side device may further include a network interface 146, and the interface is, for example, a Common Public Radio Interface (CPRI).

Specifically, the network-side device 1400 in this embodiment of this application further includes instructions or a program stored in the memory 145 and capable of running on the processor 144. The processor 144 invokes the instructions or the program in the memory 145 to perform the steps performed by the network-side device in the method performed by the modules shown in FIG. 5 or FIG. 6, and a same technical effect is achieved. To avoid repetition, details are not described herein again.

An embodiment of this application further provides a readable storage medium. The readable storage medium stores a program or instructions. When the program or the instructions are executed by a processor, each process corresponding to the terminal in the foregoing communication method embodiments is implemented, and a same technical effect can be achieved. To avoid repetition, details are not described herein again.

The processor is a processor in the terminal described in the foregoing embodiments. The readable storage medium includes a computer-readable storage medium, for example, a computer read-only memory (ROM), a random access memory (RAM), a magnetic disk, or an optical disc. In some examples, the readable storage medium may be a non-transitory readable storage medium.

An embodiment of this application further provides a readable storage medium. The readable storage medium stores a program or instructions. When the program or the instructions are executed by a processor, each process corresponding to the network-side device in the foregoing communication method embodiments is implemented, and a same technical effect can be achieved. To avoid repetition, details are not described herein again.

The processor is a processor in the network-side device in the foregoing embodiments. The readable storage medium includes a computer-readable storage medium, for example, a computer read-only memory (ROM), a random access memory (RAM), a magnetic disk, or an optical disc. In some examples, the readable storage medium may be a non-transitory readable storage medium.

An embodiment of this application further provides a chip. The chip includes a processor and a communication interface. The communication interface is coupled to the processor. The processor is configured to run a program or instructions to implement each process corresponding to the terminal in the foregoing communication method embodiments, and a same technical effect can be achieved. To avoid repetition, details are not described herein again.

An embodiment of this application further provides a chip. The chip includes a processor and a communication interface. The communication interface is coupled to the processor. The processor is configured to run a program or instructions to implement each process corresponding to the network-side device in the foregoing communication method embodiments, and a same technical effect can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement each process corresponding to the terminal in the foregoing communication method embodiments, and a same technical effect can be achieved. To avoid repetition, details are not described herein again.

An embodiment of this application further provides a computer program/program product. The computer program/program product is stored in a storage medium. The computer program/program product is executed by at least one processor to implement each process corresponding to the network-side device in the foregoing communication method embodiments, and a same technical effect can be achieved. To avoid repetition, details are not described herein again.

An embodiment of this application further provides a communication system, including a terminal and a network-side device. The terminal may be configured to perform the steps performed by the terminal in the foregoing method embodiment, and the network-side device may be configured to perform the steps performed by the network-side device in the foregoing method embodiment.

In embodiments of this application, the network-side device sends the first configuration information to the terminal, so that the terminal may determine a result of association between the at least one SSB and the flexible PRACH resource based on the first configuration information, to configure the association between the at least one SSB and the flexible PRACH resource, thereby flexibly configuring an association relationship between an SSB and the PRACH resource.

It should be noted that in this specification, the term “include”, “contain”, or any of their variants is intended to cover a non-exclusive inclusion, so that a process, method, article, or apparatus that includes a list of elements not only includes those elements but also includes other elements that are not expressly listed, or further includes elements inherent to such a process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in an order shown or discussed, and may further include performing functions in a basically simultaneous manner or in a reverse order based on the functions involved. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for enabling the terminal or the network-side device to perform the methods described in embodiments of this application.

The foregoing describes embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

What is claimed is:

1. A communication method, comprising:
receiving, by a terminal, first configuration information from a network-side device, wherein the first configuration information is used to configure a flexible Physical Random Access Channel (PRACH) resource associated with at least one Synchronization Signal Block (SSB); and
determining, by the terminal, a result of association between the at least one SSB and the PRACH resource based on the first configuration information.

2. The method according to claim 1, wherein the first configuration information comprises at least one of an SSB parameter, a PRACH resource set, or an association relationship between the SSB and the flexible PRACH resource.

3. The method according to claim 2, wherein the SSB parameter comprises:
the at least one SSB associated with the flexible PRACH resource.

4. The method according to claim 1, further comprising:
receiving, by the terminal, a first activation signal from the network-side device, wherein the first activation signal is used to activate the flexible PRACH resource.

5. The method according to claim 1, further comprising:
receiving, by the terminal, a second activation signal from the network-side device, wherein the second activation signal is used to activate a first part of the flexible PRACH resource.

6. The method according to claim 5, further comprising:
receiving, by the terminal, second configuration information from the network-side device, wherein the second configuration information is used to configure a static PRACH resource associated with the at least one SSB; and
determining, by the terminal, the result of association between the at least one SSB and the PRACH resource based on the first configuration information and the second configuration information.

7. The method according to claim 6, wherein the second configuration information comprises an association relationship between the SSB and the static PRACH resource.

8. The method according to claim 6, wherein the determining, by the terminal, the result of association between the at least one SSB and the PRACH resource based on the first configuration information and the second configuration information comprises:
performing, by the terminal, mapping in a first PRACH resource set based on the at least one SSB, to obtain the result of association between the at least one SSB and the PRACH resource, wherein the first PRACH resource set comprises at least one flexible PRACH resource set and at least one static PRACH resource set.

9. The method according to claim 8, wherein the flexible PRACH resource set and the static PRACH resource set correspond to different association relationships between SSBs and PRACH resources.

10. The method according to 6, wherein the determining, by the terminal, a result of association between the at least one SSB and the PRACH resource based on the first configuration information and the second configuration information comprises:
performing, by the terminal in a second PRACH resource set, mapping from an SSB to a PRACH resource based on an association relationship that is between the SSB and the PRACH resource and that corresponds to the second PRACH resource set, to obtain the result of association between the at least one SSB and the PRACH resource, wherein the second PRACH resource set comprises at least one flexible PRACH resource set; and
performing, by the terminal in a third PRACH resource set, mapping from the SSB to the PRACH resource based on the association relationship that is between the SSB and the PRACH resource and that corresponds to the third PRACH resource set, to obtain the result of association between the at least one SSB and the PRACH resource, wherein the third PRACH resource set comprises at least one static PRACH resource set.

11. The method according to claim 10, further comprising:
determining at least one of a second mapping cycle, a second association period, or a second association pattern period, wherein the second mapping cycle is a cycle in which the at least one SSB is associated with the second PRACH resource set for one round, the second association period comprises at least one second mapping cycle, and the second association pattern period comprises at least one second association period; and
determining at least one of a third mapping cycle, a third association period, or a third association pattern period, wherein the third mapping cycle is a cycle in which the at least one SSB is associated with the third PRACH resource set for one round, the third association period comprises at least one third mapping cycle, and the third association pattern period comprises at least one third association period.

12. A communication method, comprising:
determining, by a network-side device, first configuration information, wherein the first configuration information is used to configure a flexible Physical Random Access Channel (PRACH) resource associated with at least one Synchronization Signal Block (SSB); and
sending, by the network-side device, the first configuration information to a terminal.

13. The method according to claim 12, wherein the first configuration information comprises at least one of an SSB parameter, a PRACH resource set, or an association relationship between the SSB and the flexible PRACH resource.

14. The method according to claim 13, wherein the SSB parameter comprises:
the at least one SSB associated with the flexible PRACH resource.

15. The method according to claim 12, further comprising:
sending, by the network-side device, a first activation signal to the terminal, wherein the first activation signal is used to activate the flexible PRACH resource.

16. The method according to claim 12, further comprising:
sending, by the network-side device, a second activation signal to the terminal, wherein the second activation signal is used to activate a first part of the flexible PRACH resource.

17. The method according to claim 16, further comprising:
sending, by the network-side device, second configuration information to the terminal, wherein the second configuration information is used to configure a static PRACH resource associated with the at least one SSB.

18. The method according to claim 17, wherein the second configuration information comprises an association relationship between the SSB and the static PRACH resource.

19. A network-side device, comprising a processor and a memory, wherein the memory stores a program or instructions capable of running on the processor, and the program or the instructions are executed by the processor to implement the steps of the communication method according to claim 12.

20. A terminal, comprising a processor and a memory, wherein the memory stores a program or instructions capable of running on the processor, and the program or the instructions are executed by the processor to cause the terminal to:
receive first configuration information from a network-side device, wherein the first configuration information is used to configure a flexible Physical Random Access Channel (PRACH) resource associated with at least one Synchronization Signal Block (SSB); and
determine a result of association between the at least one SSB and the PRACH resource based on the first configuration information.
